(19) United States
(12) Patent Application Publication
(10) Pub. No.: US 2012/0111937 A1
(43) Pub. Date: May 10, 2012

(54) VALET PARKING SYSTEM AND METHOD

(76) Inventor: Lori C. Rogich, Las Vegas, NV (US)

(21) Appl. No.: 13/178,354

(22) Filed: Jul. 7, 2011

(51) Int. Cl. G06K 5/00

(52) U.S. Cl. 235/380

(57) ABSTRACT

A valet system including a valet computer communicatively linked to one or more hand-held interface devices. The interface devices allow a valet attendant to input a vehicle owner's/driver's text number, email address and/or vehicle make, model and color. The interface devices transmit acquired vehicle owner/driver and vehicle data to the valet computer which then transmits an electronic virtual valet ticket to the vehicle owner's/driver's smart phone. When the vehicle driver/owner desires to depart from the establishment, the driver/owner electronically replies to the text message and/or email. The driver's/owner's electronic reply is transmitted to the valet computer notifying a valet attendant to retrieve the vehicle identified by the electronic virtual number code (or other code). Before returning possession of the vehicle to the driver/owner, the valet attendant confirms that both the interface device and the driver's/owner's smart phone display the same electronic virtual number code.

### FIELD OF THE INVENTION

The embodiments of the present invention relate to a valet parking system, which eliminates the need for paper valet tickets, and a method of using the same.

### BACKGROUND

Valet parking is a service provided by establishments such as casinos, hotels, restaurants, stadiums, and other gathering places to drivers/owners of vehicles. Valet parking is typically comprised of the valet attendant giving the driver/owner a paper valet ticket stub in exchange for possession of the vehicle. A number code is listed on the ticket stub. This number code matches the number code on the paper valet ticket retained by the valet attendant. The valet attendant then parks the vehicle. Upon return, the driver/owner gives the ticket stub to the valet attendant. The valet attendant retrieves the vehicle based on the number code. The valet attendant then confirms both the ticket stub and paper valet ticket have the same number code before returning possession of the vehicle to the driver/owner.

It would be beneficial to create a valet system and method which eliminates the need for paper valet tickets. In addition, a paperless valet system would increase the efficiency and method of managing a valet operational system.

### SUMMARY

Accordingly, in broad terms, one embodiment of the present invention comprises the use of a valet computer, server or similar computer device (generally termed a “computer”) to manage a valet operational system. The valet computer is communicatively linked to one or more hand-held devices which are configured to serve as an interface between a valet attendant and vehicle driver/owner. More specifically, the hand-held device allows the valet attendant to input a vehicle driver/owner's information. Such information includes the driver/owner's name, text number and/or e-mail address as well as the vehicle make, model and color. The hand-held device transmits the acquired information to the valet computer which then responds by transmitting an electronic virtual valet ticket to the vehicle driver's/owner's smart phone and/or similar mobile device. The driver/owner receives the electronic virtual valet ticket by text message and/or email. The electronic virtual valet ticket contains a number code. When the vehicle driver/owner is ready to depart from the establishment, he or she electronically replies to the text message and/or email. The driver's/owner's electronic reply is sent to the valet computer system and a valet attendant is notified to retrieve the vehicle based on the electronic virtual number code. Before returning possession of the vehicle to the driver/owner, the valet attendant confirms that both the valet hand-held device, and the driver's/owner's smart phone and/or similar mobile device have the same electronic virtual number code. This confirmation is accomplished by the driver/owner showing the electronic virtual number code displayed on his or her smart phone and/or similar mobile device to the valet attendant.

Other variations, embodiments and features of the present invention will become evident from the following detailed description, drawings and claims.

### BRIEF DESCRIPTION OF THE DRAWINGS

FIG. 1 illustrates a block diagram of a system according to the embodiments of the present invention;

FIG. 2 illustrates a block diagram of a valet computer configuration according to the embodiments of the present invention;

FIGS. 3A and 3B illustrate a valet computer database library according to the embodiments of the present invention;

FIG. 4 illustrates a block diagram of a hand-held interface device according to the embodiments of the present invention;

FIGS. 5A and 5B illustrate a screen shot depicting an electronic virtual valet ticket according to the embodiments of the present invention;

FIG. 6 illustrates a flow chart of a methodology according to the embodiments of the present invention; and

FIGS. 7A and 7B illustrate exemplary vehicle request messages of the type a vehicle owner/driver may trigger by activating a communication link associated with an electronic virtual valet ticket according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The embodiments of the present invention relate to a valet system and method of use involving a valet computer having processing power and memory and communicatively linked to one or more hand-held interface devices utilized by valets. The valet computer is configured to communicate with smart phone and/or similar mobile devices possessed by vehicle owner/drivers to transmit at least an electronic virtual valet ticket for display thereon while the one or more hand-held interface devices are configured to receive vehicle owner/driver and vehicle information and transmit the same to the valet computer, and in some instances capture a unique code associated with said electronic virtual valet ticket.

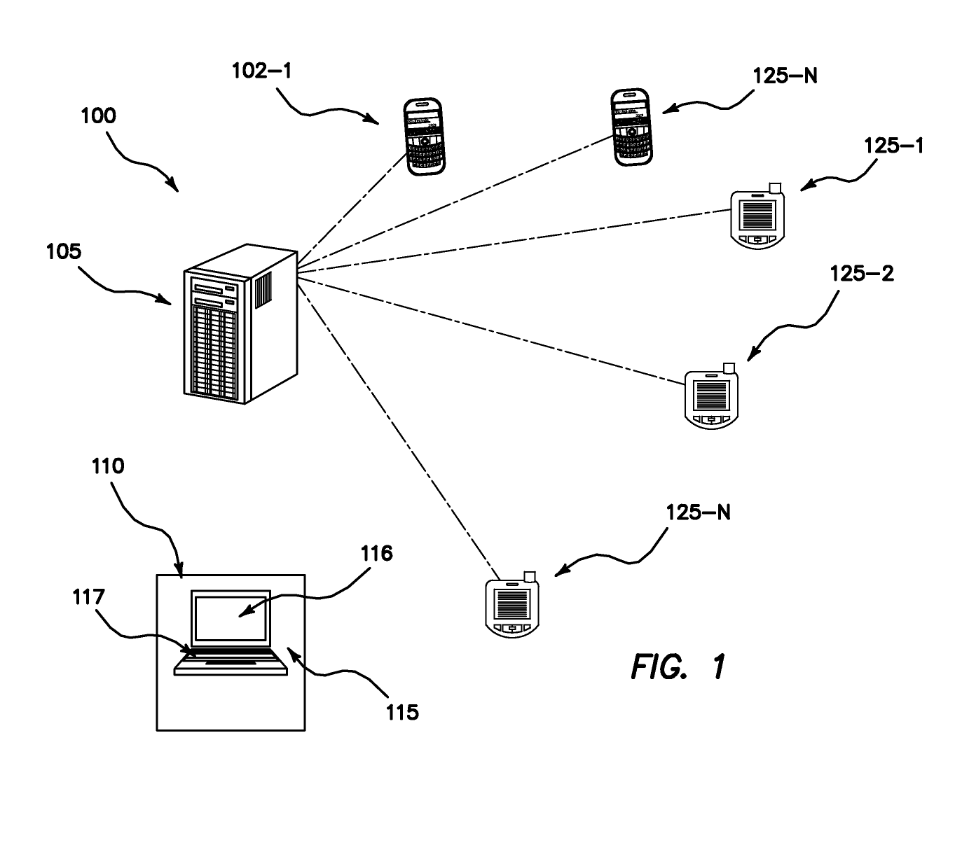

FIG. 1 shows a block diagram of a system 100 according to the embodiments of the present invention. The system 100 comprises at least one valet computer 105 (or similar type computer system capable of maintaining databases, running one or more software applications and communicating with remote devices), a valet station 110, including a valet terminal 115, and one or more hand-held interface devices 125-1 through 125-N communicatively linked to said valet computer 105. The valet computer 105 may be located at the business offering the valet computer or may be located remotely therefrom. For a business (e.g., casino operator) with multiple locations, the valet computer 105 may be located at one of the casino properties or remotely from the multiple casino properties. The system 100 may also incorporate multiple valet computers rather than a single valet computer 105. The valet terminal 115 includes at least a display 116 and user interface 117 and communicates with the valet computer 105 and/or one or more hand-held interface devices 125-1 through 125-N. For example, the valet terminal 115 may comprise a smart or dumb laptop or desk top computer. Communications between the hand-held interface devices 125-1 through 125-N, valet terminal 115 and/or valet computer 105 may be wireless or wired. Those skilled in the art will recognize that the embodiments of the present invention may operate without the valet terminal 115. In such a system, the one or more hand-held interface devices 125-1 through 125-N are used to accomplish the objectives of the valet terminal 115 as described herein.

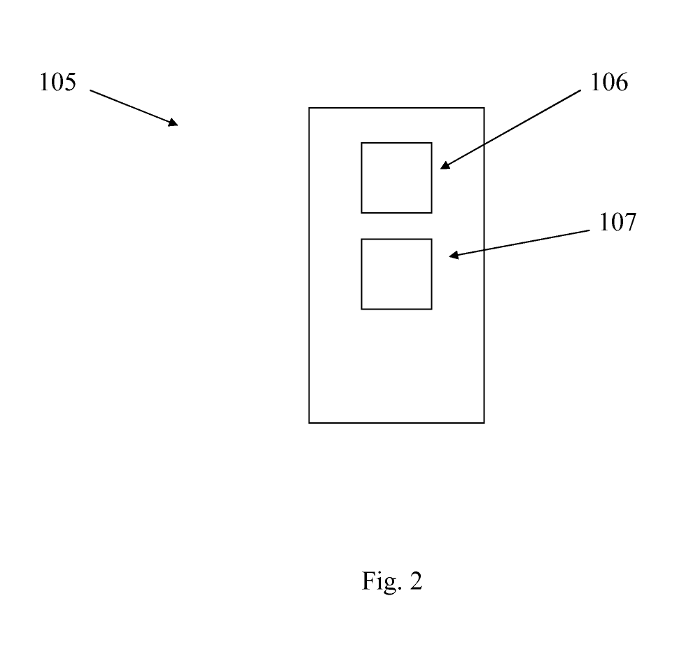

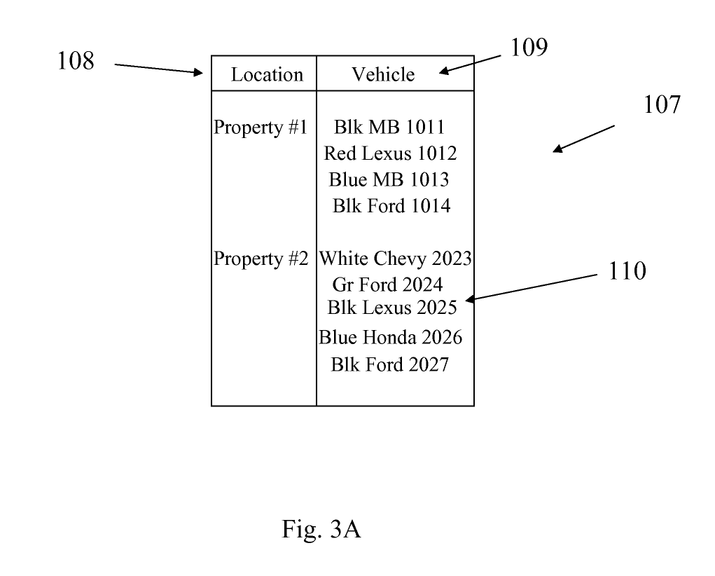

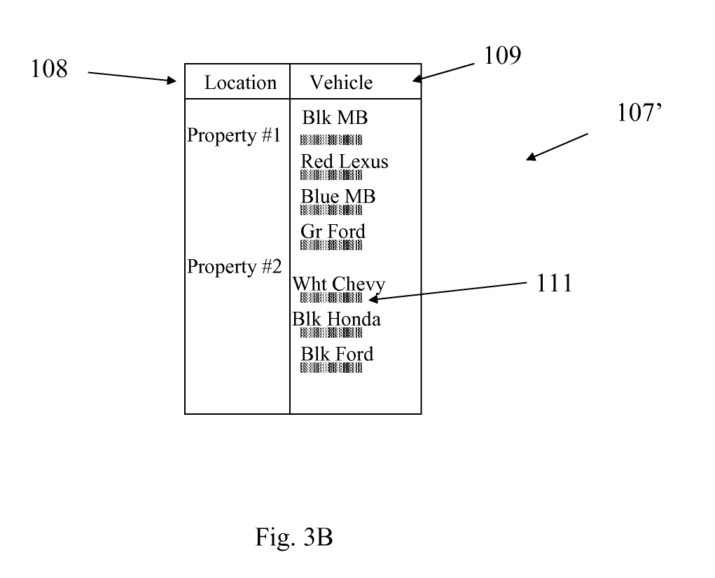

The valet computer 105, as shown in FIG. 2, runs a valet application software program 106 which facilitates the system 100 operations detailed below and maintains a database library 107, 107′ comprising at least one or more property location databases 108, 108′ and vehicle owner/driver/vehicle databases 109, 109′ as described relative to FIGS. 3A and 3B. Each vehicle owner/driver and vehicle information entry in the vehicle owner/driver/vehicle database 109, 109′ also includes a unique number code 110, unique barcode 111 and/or other unique code, such as a QR code, which creates a correspondence between the vehicle owner/driver and vehicle, and electronic virtual ticket as described below. Also stored on the valet computer 105 is a series of electronic virtual valet tickets or at least unique codes such as number codes or barcodes useable with generated or issued electronic virtual valet tickets.

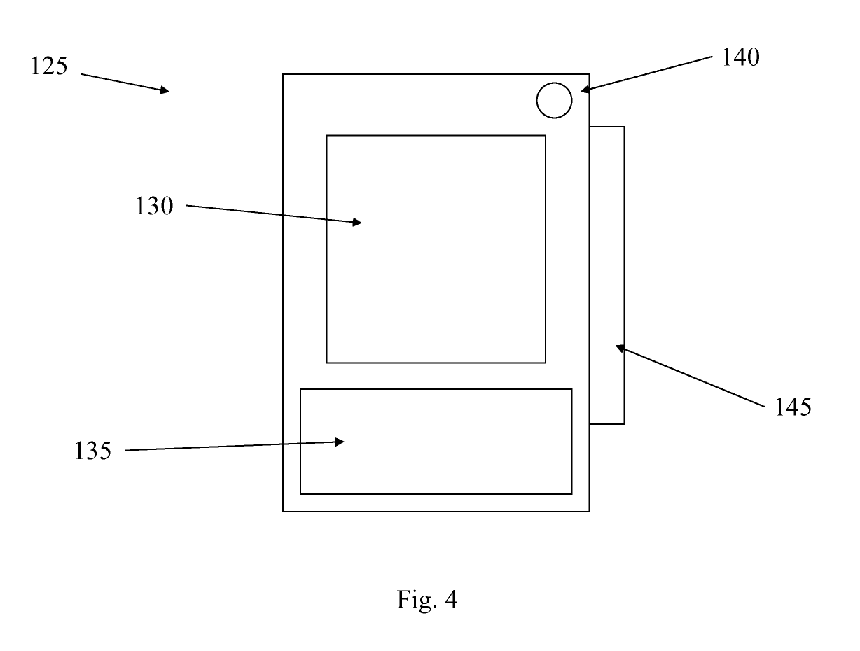

Now referring to FIG. 4, the one or more hand-held interface devices 125-1 through 125-N include a display 130 which may utilize touch screen technology. Other interfaces, such as a button panel 135, allows valet operators to manually input vehicle owner/driver and vehicle information, send text messages and/or emails to vehicle owner/driver smart phones 102-1 through 102-N (or similar hand-held communication devices such as personal digital assistants (PDA)) or email servers and verify vehicle owner/drivership. Depending on the embodiment, the one or more hand-held interface devices 125-1 through 125-N may also include a camera 140 and magnetic card readers 145. Any suitable hand-held interface device 125 may be used to facilitate the system and method disclosed herein. The hand-held interface device 125 runs one or more valet software applications which facilitate communications between the hand-held device 125 and valet computer 105, valet terminal 115 and vehicle owner/driver smart phones 102-1 through 102-N, input of vehicle owner/driver and vehicle information and verification of electronic virtual valet tickets on vehicle owner/driver smart phones 102-1 through 102-N.

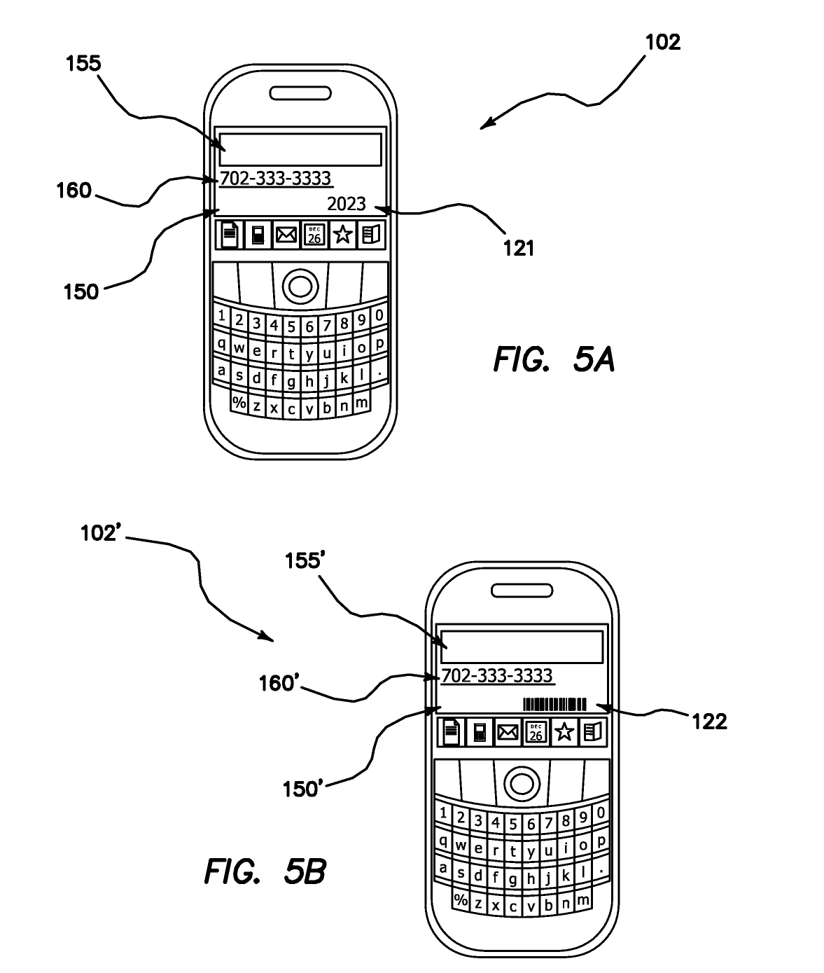

FIGS. 5A and 5B show an electronic virtual valet ticket 150, 150′ of the type which the system 100 generates or issues displayed on a vehicle owner/driver smart phone 102, 102′. The electronic virtual valet ticket 150, 150′ contains a unique number code 121 or barcode 122 or other code, such as a QR code, and liability information 155, 155′ and communication link 160, 160′. Communication link 160, 160′ may be the phone number of the valet station 110 and may be configured to either (i) call the valet station 110 such that the vehicle owner/driver may verbally request that his or her vehicle be made available; or (ii) transmit a text message, instant message and/or email to the valet terminal 115 requesting that his or her vehicle be made available for pick up. With the text message, the system 100 may also be configured such that once the communication link 160, 160′ is activated a confirmation window appears on the display of the vehicle owner/driver smart phone 102-1 through 102-N allowing the vehicle owner/driver to confirm the request that his or her vehicle be made available. From the valet station 110, a valet manager may instruct one of the valets verbally or via the one or more hand held devices 125-1 through 125-N to retrieve the vehicle.

In another embodiment, the transmission of the text message, instant message and/or email message responsive to the depression of the active link 160, 160′ may be transmitted directly to the one or more hand-held devices 125-1 through 125-N thereby alerting a valet staff that the vehicle requires retrieval. That is, the valet station 110 and terminal 115 need not be present in the system or is bypassed if present.

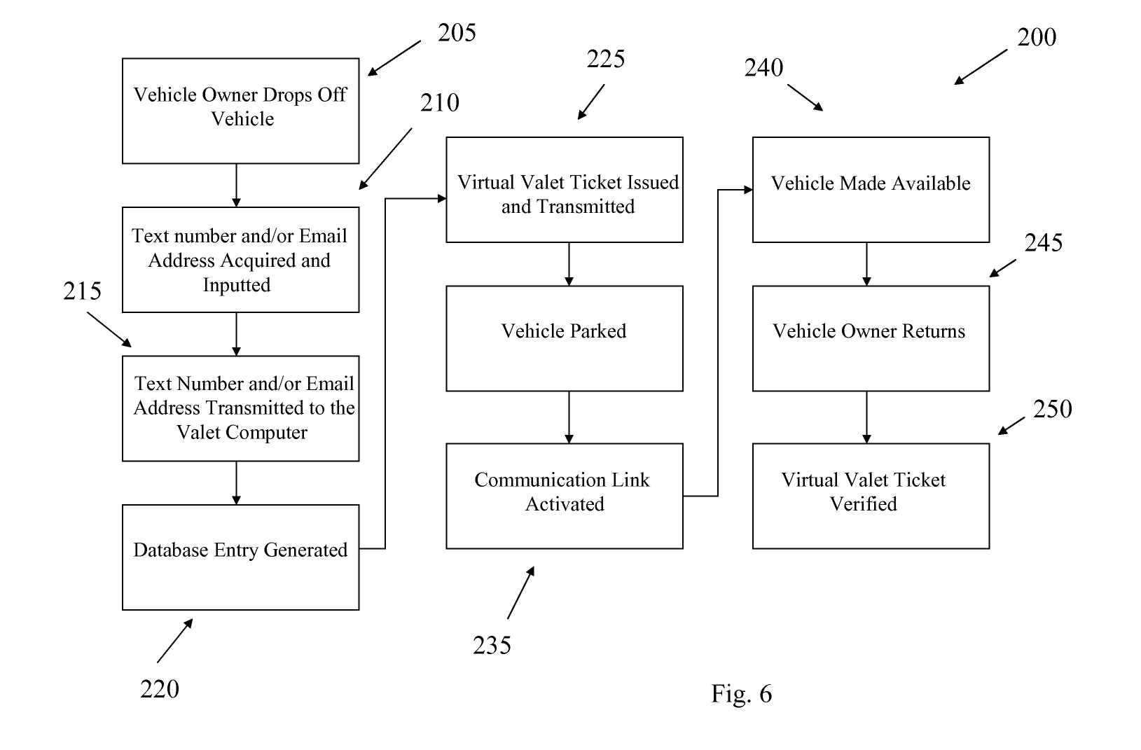

FIG. 6 shows a flow chart 200 detailing a methodology according to the embodiments of the present invention. At 205, a vehicle owner/driver pulls up to a valet location outside of a business offering valet services. Such businesses include restaurants, casinos, stadiums, airports and the like. At 210, a valet requests and inputs the text number and/or email address of the vehicle owner/driver and vehicle information (e.g., make, model, color, license plate number, etc.) into one of the hand-held interface devices 125. Optionally and additionally, the valet may swipe the vehicle owner's/driver's state-issued driver's license through the magnetic card reader 145 of one of the hand-held interface devices 125-1 through 125-N. The application software running on the hand-held interface device 125 captures the desired information such as vehicle owner/driver name and driver's license number. Alternatively or additionally, the valet may swipe a driver's/owner's club membership card or VIP card associated with the casino or other establishment. In such an embodiment, the valet system 100 communicates with the casino management system (or other business) such that casino personnel may be prepared for the guest. Such preparation provides the casino with an opportunity to meet the guest or otherwise cater to the guest as desired.

At 215, responsive to the input of the text number and/or email address and vehicle information, and optionally the swiped driver's license, the text number and/or email address and vehicle information, is transmitted to the valet computer 105. At 220, the application software running on the valet computer 105 generates a database entry for the subject vehicle. At 225, the valet computer 105 issues an electronic virtual valet ticket 150, 150′ using a next available unique number code 121 or barcode 122 and transmits the electronic virtual valet ticket 150, 150′ to the vehicle owner's/driver's smart phone 102 via the text number and/or transmits the electronic virtual valet ticket 150, 150′ to the vehicle owner/driver email address provided by the vehicle owner/driver. The email may then be accessed by the vehicle owner/driver via an Internet browser available via the smart phone 102. Optionally, the valet computer 105 may also transmit the electronic virtual valet ticket 150, 150′ to the hand-held interface devices 125-1 through 125-N. At 230, the valet parks the vehicle in the valet parking area.

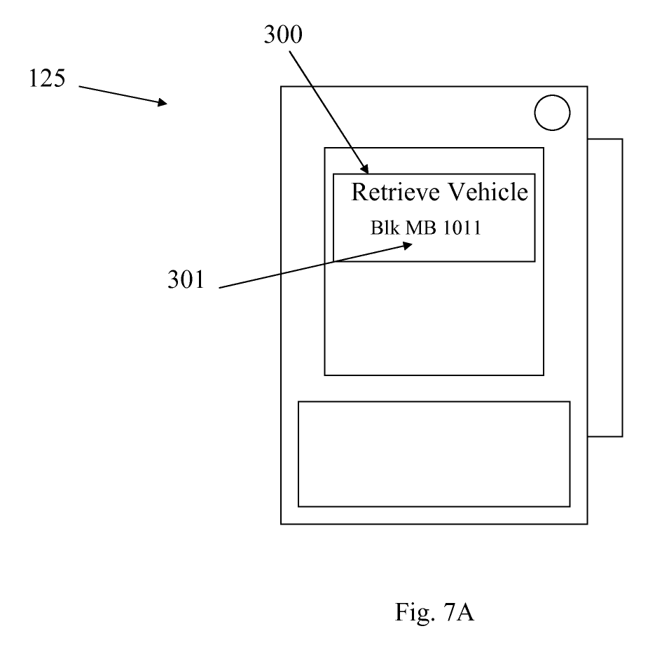

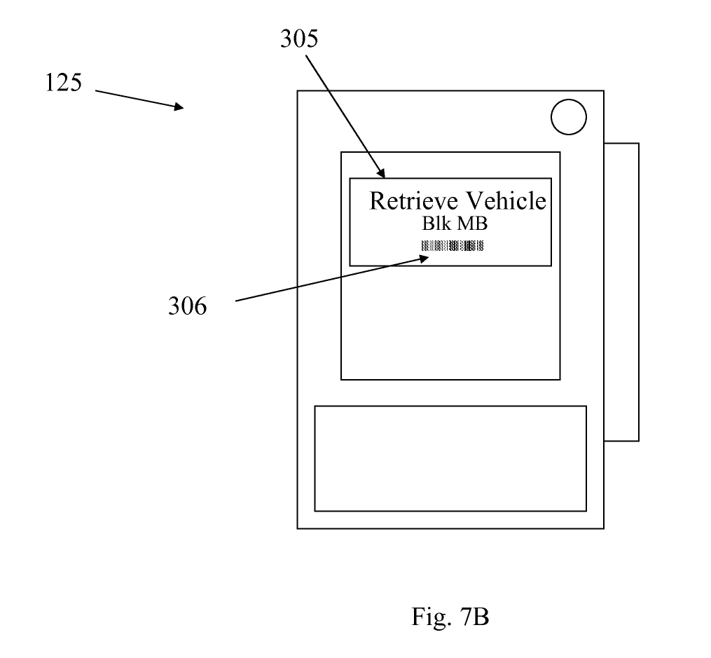

At 235, the vehicle owner/driver activates (i.e., touching or clicking on) the communication link 160, 160′ forming part of the electronic virtual valet ticket 150, 150′ transmitted to the vehicle owner/driver smart phone 102. Activating the communication link 160, 160′ causes the transmission of a vehicle request to the valet station 110 and/or valet computer 105 and/or one or more hand-held interface devices 125-1 through 125-N. Such a vehicle request may be transmitted by a vehicle owner/driver 10 or 15 minutes prior to the vehicle owner/driver returning to pick up his or her vehicle. FIGS. 7A and 7B show exemplary vehicle requests 300, 305 of the type automatically transmitted (as set forth above, a vehicle owner/driver may need to confirm the transmission of the vehicle request subsequent to activation of the communication link 160, 160′) responsive to activation of the communication link 160, 160′. As shown, the vehicle request 300 is transmitted to, and depicted on, hand-held interface devices 125 but it may also appear on the valet terminal 115. The vehicle request 300 includes the unique number code 301 and the vehicle request 305 includes the barcode 306. Alternatively, activation of the communication link 160, 160′ may open a text window in which a vehicle owner/driver may type a text using the hand-held device 102 providing specific details such as the time vehicle owner/driver intends to return to the valet station 110 for retrieving the vehicle, need for an item within the vehicle, etc.

At 240, responsive to the transmitted vehicle request, the valet makes the vehicle available. At 245, the vehicle owner/driver returns to pick up his or her vehicle and presents the electronic virtual valet ticket 150, 150′ depicted on the display of the vehicle owner/driver smart phone 102. At 250, the valet verifies the presented electronic virtual valet ticket 150, 150′. Verification may comprise comparing the unique number code 121 with information stored in database 109, 109′ maintained by the valet computer 105. For example, the valet may enter into the hand-held interface device 125 the unique number code 121 from the electronic virtual valet ticket 150, 150′ depicted on the vehicle owner/driver smart phone 102. Responsive thereto, the valet computer 105 locates in the database 109, 109′ the corresponding vehicle owner/driver and vehicle information and transmits said vehicle owner/driver and vehicle information to the hand-held interface device 125 allowing verification of the vehicle owner/driver and vehicle make, model, color, etc. Verification may also comprise the valet utilizing the hand-held interface device 125 to capture the barcode 122 on the electronic virtual valet ticket 150, 150′ presented by the vehicle owner/driver. In such an embodiment, the camera 140 of the hand-held device 125 is used to capture the barcode 122 from the electronic virtual valet ticket 150′. The captured barcode 122 is transmitted to the valet computer 105 and compared to those stored in the database 109, 109′. Upon locating a barcode match, the valet computer 105 transmits corresponding vehicle owner/driver and vehicle information from database 109, 109′ to the hand-held interface device 125 allowing verification of the vehicle owner/driver and vehicle make, model, color, etc.

The embodiments of the present invention eliminate the need for paper valet tickets thus creating a more “green” valet system. Electronic virtual valet tickets reduce the production and distribution costs related to traditional paper-based, valet ticketing methods. Electronic valet tickets increase customer convenience by providing a new and simple way to offer valet services. The disclosed method is compatible with the increased functionality of today's new messaging tools such as mobile devices and/or smart phones.

In other embodiments, the business offering the valet service may also incorporate advertisements, coupons, promotions or the like with the electronic virtual valet ticket. For example, at a casino location, the electronic virtual valet ticket may include a dinner coupon or free slot play. Moreover, the system 100 may be adapted to maintain a history of visits such that frequent guests and customers may be targeted via text and/or email messages at a later date. For example, if a casino operator is aware that an individual has visited one or more of its properties frequently during a given time period, the casino operator may utilize the known text number and/or email address to communicate offers to the individual. Such offers may include but are not limited to invitations to join the casino's slot club.

Although the invention has been described in detail with reference to several embodiments, additional variations and modifications exist within the scope and spirit of the invention as described and defined in the following claims.

I claim:

1. A valet system comprising:
a valet computer maintaining one or more databases for storing vehicle owner/driver and/or vehicle information;
one or more hand-held interface devices communicatively linked to said valet computer, said one or more hand-held interface devices for receiving said vehicle owner/driver and/or vehicle information and transmitting said vehicle owner/driver and/or vehicle information to said valet computer; and
wherein responsive to receiving said vehicle owner/driver and/or vehicle information said valet computer issues an electronic virtual valet ticket and causes said electronic virtual valet ticket to be transmitted to a hand-held communication device possessed by said vehicle owner/driver, said electronic virtual valet ticket including a unique identifier associated with said vehicle owner/driver and/or vehicle information and a communication link facilitating communication between a vehicle owner/driver and said valet computer and/or hand-held interface devices.

2. The valet system of claim 1 wherein said one or more hand-held interface devices include a magnetic card reader.

3. The valet system of claim 1 wherein said one or more hand-held interface devices includes means for capturing a barcode.

4. The valet system of claim 1 wherein said unique identifier is a number code.

5. The valet system of claim 1 wherein said unique identifier is a barcode.

6. The valet system of claim 1 wherein said hand-held device possessed by a vehicle owner/driver is a smart phone.

7. The valet system of claim 1 wherein said electronic virtual valet ticket is transmitted via text and/or email from said valet computer to said hand-held device.

8. A valet system comprising:
a valet computer maintaining one or more databases for storing vehicle owner/driver and/or vehicle information;
one or more hand-held interface devices communicatively linked to said valet computer, said one or more hand-held interface devices including means for a valet to input vehicle and/or vehicle information and for transmitting said vehicle owner/driver and/or vehicle information to said valet computer;
a valet station including a valet terminal communicatively linked to said valet computer and said one or more hand-held interface devices; and
wherein responsive to receiving said vehicle owner/driver and/or vehicle information said valet computer issues an electronic virtual valet ticket and transmits said electronic virtual valet ticket to a hand-held communication device possessed by said vehicle owner/driver, said electronic virtual valet ticket including a unique identifier associated with said vehicle owner/driver and/or vehicle information and an active communication link facilitating communication between a vehicle owner/driver and said valet computer and/or valet station.

9. The valet system of claim 8 wherein said one or more hand-held interface devices include a magnetic card reader.

10. The valet system of claim 8 wherein said unique identifier is a number code.

11. The valet system of claim 8 wherein said unique identifier is a barcode.

12. The valet system of claim 8 wherein said hand-held device possessed by a vehicle owner/driver is a smart phone.

13. The valet system of claim 8 wherein said electronic virtual valet ticket is transmitted via text message and/or email from said valet computer to said hand-held device.

14. A method comprising:
utilizing a valet computer communicatively linked to one or more hand-held interface devices for
maintaining on said valet computer one or more databases for storing vehicle owner/driver and/or vehicle information;
receiving vehicle owner/driver and/or vehicle information via said one or more hand-held interface devices;
transmitting from said one or more hand-held interface devices to said central computer said vehicle owner/driver and/or vehicle information;
issuing an electronic virtual valet ticket from a database stored on said valet computer;
transmitting said electronic virtual ticket to a hand-held communication device possessed by a vehicle owner/driver; and
responsive to activation of a communication link associated with said electronic virtual valet ticket, transmitting a vehicle request to said valet computer and/or one or more hand-held interface devices.
